(19) United States
(12) Patent Application Publication
(10) Pub. No.: US 2014/0124419 A1
(43) Pub. Date: May 8, 2014

(54) FUEL SEPARATION DEVICE

(71) Applicant: HONDA MOTOR CO., LTD., Tokyo (JP)

(72) Inventors: Hiroshi CHISHIMA, Wako (JP); Hirotsugu KUDO, Wako (JP); Masayoshi KAWAGUCHI, Wako (JP); Daiko TSUTSUMI, Wako (JP); Kenji SHIGETOYO, Wako (JP)

(73) Assignee: HONDA MOTOR CO., LTD., Tokyo (JP)

(21) Appl. No.: 14/067,962

(22) Filed: Oct. 31, 2013

(30) Foreign Application Priority Data
Nov. 2, 2012 (JP) 2012-242445

(51) Int. Cl. F02M 37/22

(52) U.S. Cl. CPC F02M 37/223
USPC 210/90; 210/85

(57) ABSTRACT

A fuel separation device includes a raw fuel tank, a separator, a first density sensor, and a state determination element. The raw fuel tank is to store raw fuel. The separator is to separate the raw fuel supplied from the raw fuel tank into high-octane fuel and low-octane fuel. The high-octane fuel contains a high-octane component by a larger amount than an amount of a high-octane component in the raw fuel. The low-octane fuel contains a high-octane component by a smaller amount than the amount of the high-octane component in the raw fuel. The first density sensor is configured to output a signal corresponding to a density of the high-octane component contained in the low-octane fuel. The state determination element is configured to determine a state of the separator in accordance with the density indicated by the signal output from the first density sensor.

### CROSS-REFERENCE TO RELATED APPLICATIONS

The present application claims priority under 35 U.S.C. §119 to Japanese Patent Application No. 2012-242445, filed Nov. 2, 2012, entitled “Fuel Separation Device.” The contents of this application are incorporated herein by reference in their entirety.

### BACKGROUND

1. Field

The present disclosure relates to a fuel separation device.

2. Description of the Related Art

An on-vehicle fuel separation device that separates raw fuel into high-octane fuel and low-octane fuel by using a fuel separation film is known (for example, see Japanese Unexamined Patent Application Publication No. 2010-53769). In such a fuel separation device, raw fuel is fed to one side of a fuel separation film and a negative pressure is applied to the other side of the fuel separation film. Then, fuel transmitted through the fuel separation film becomes high-octane fuel, and fuel not transmitted through the fuel separation film becomes low-octane fuel.

In the above-described fuel separation device, the separation performance of the fuel separation film is deteriorated over time. The deterioration may occur because pores of the fuel separation film are clogged, for example, when solids flow into the pores. Also, the separation performance may be deteriorated because of structural disorder (fracture) of the separation film. If the separation performance is deteriorated, the yield (extraction) of the high-octane fuel is decreased.

Various methods are suggested for determining abnormality of such a separator (separation film). For example, a fuel separation device that determines deterioration of a separation film based on the density of raw fuel and the density of low-octane fuel is suggested (see Japanese Unexamined Patent Application Publication No. 2010-53769). Also, an abnormality determination device for a fuel separator that determines the presence of abnormality of the separator based on the differential pressure between the inlet pressure of raw fuel and the outlet pressure of low-octane fuel at the separator is suggested (see Japanese Unexamined Patent Application Publication No. 2010-13971). Further, an abnormality determination device for a fuel separator that determines the presence of abnormality of the separator based on the negative pressure of the separator and the discharge pressure of high-octane fuel is suggested (see Japanese Unexamined Patent Application Publication No. 2010-1755).

### SUMMARY

According to one aspect of the present invention, a fuel separation device includes a raw fuel tank, a separator, a first density sensor, and a state determination element. The raw fuel tank is to store raw fuel. The separator is to separate the raw fuel supplied from the raw fuel tank into high-octane fuel and low-octane fuel. The high-octane fuel contains a high-octane component by a larger amount than an amount of a high-octane component in the raw fuel. The low-octane fuel contains a high-octane component by a smaller amount than the amount of the high-octane component in the raw fuel. The first density sensor is configured to output a signal corresponding to a density of the high-octane component contained in the low-octane fuel. The state determination element is configured to determine a state of the separator in accordance with the density indicated by the signal output from the first density sensor.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a configuration explanatory view of a fuel supply device according to an embodiment of this application.

FIG. 2 is a flowchart illustrating a procedure of negative-pressure control processing.

FIGS. 3A to 3D are explanatory views relating to open/close processing of a negative-pressure control system.

FIG. 4 is an explanatory view relating to a change in internal pressure of a condenser caused by negative-pressure control.

FIG. 5 is a flowchart illustrating a procedure of first separator-state determination processing.

FIG. 6 is a flowchart illustrating a procedure of second separator-state determination processing.

FIG. 7 is a flowchart illustrating a procedure of third separator-state determination processing.

FIGS. 8A to 8C are views illustrating relationships between various parameters and states of a separator according to this embodiment.

FIGS. 9A and 9B are views illustrating relationships between various parameters and states of a separator according to a modification.

### DESCRIPTION OF THE EMBODIMENTS

The embodiments will now be described with reference to the accompanying drawings, wherein like reference numerals designate corresponding or identical elements throughout the various drawings.

### Configuration

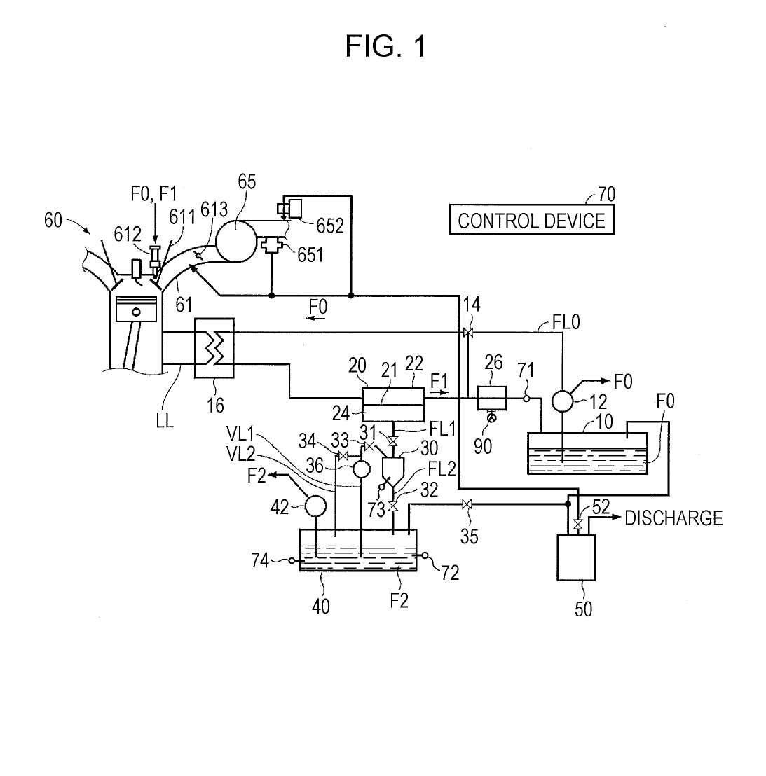

A fuel supply device (also serving as a fuel separation device) illustrated in FIG. 1 includes a raw fuel tank 10, a separator 20, a condenser 30, a high-octane fuel tank 40, a canister 50, and a control device (or an electronic control unit (ECU)) 70. The fuel supply device is mounted on a vehicle, and supplies fuel to an internal combustion engine 60, which is also mounted on the vehicle.

The raw fuel tank 10 stores normal or commercial gasoline supplied through an oil supply port, as raw fuel F0. The pressure of the raw fuel F0 stored in the raw fuel tank 10 is increased by a high-pressure supply pump (raw fuel sending device) 12 to a designated pressure, and then the raw fuel F0 is supplied to the internal combustion engine 60.

Also, after the pressure the raw fuel F0 is increased by the high-pressure supply pump 12 to the designated pressure, the raw fuel F0 is heated by a heater 16 and is sent to the separator 20 through a raw fuel channel FL0.

If a three way valve 14 shuts off the raw fuel tank 10 from communication with the heater 16, the raw fuel F0 is returned to the raw fuel tank 10 not through the separator 20, but through a cooler (radiator) 26.

The heater 16 is formed of a heat exchanger that exchanges heat between a cooling medium of the internal combustion engine 60 and the raw fuel. The heater 16 may be formed of an electric heater instead of the heat exchanger.

By adjusting the operation of the high-pressure supply pump 12, the supply amount of the raw fuel F0 in the raw fuel channel FL0 to the separator 20 is adjusted. Additionally or alternatively, for example, the supply amount of the raw fuel F0 to the separator 20 may be adjusted, for example, by adjusting the opening degree of the three way valve 14 or by opening and closing the three way valve 14.

The fuel supply device further includes a cooling medium circulation channel LL for circulating a cooling medium (for example, water) for cooling the internal combustion engine 60. The cooling medium circulation channel LL is provided with a pump (not illustrated) for circulating the cooling medium through the cooling medium circulation channel LL. The cooling medium circulation channel LL exchanges heat between the cooling medium and the raw fuel F0 flowing through the raw fuel channel FL0, in the heater 16 located downstream of the internal combustion engine 60.

Also, by adjusting the opening degree of an open/close mechanism (not illustrated, for example, a flow rate adjusting valve) in the cooling medium circulation channel LL or by opening and closing the open/close mechanism, the flow rate of the cooling medium is adjusted, and consequently, the heating amount of the raw fuel F0 in the heater 16 is adjusted.

When the raw fuel F0 stored in the raw fuel tank 10 is vaporized, vaporized fuel V containing hydrocarbon and a high-octane component is generated. The vaporized fuel V is supplied from the raw fuel tank 10 to the canister 50.

The separator 20 separates the raw fuel F0 into high-octane fuel F2 and low-octane fuel F1 by pervaporation (PV). The separator 20 includes a separation film 21 that selectively transmits the high-octane component in the raw fuel (gasoline), and a high-pressure chamber 22 and a low-pressure chamber 24 partitioned by the separation film 21.

The high-octane fuel F2 is fuel containing the high-octane component by a larger amount than that of the raw fuel F0. For example, the high-octane fuel F2 is alcohol such as ethanol. The low-octane fuel F1 is fuel containing the high-octane component by a smaller amount than that of the raw fuel F0.

To be more specific, the raw fuel F0 in a high-temperature and high-pressure state is supplied to the high-pressure chamber 22 of the separator 20, while the low-pressure chamber 24 is maintained with a negative pressure. Hence, the high-octane component contained in the raw fuel F0 is transmitted through the separation film 21 and is leached to the low-pressure chamber 24. If the amount of the high-octane component in the raw fuel F0 increases, the octane number of the transmitted fluid increases. Accordingly, the high-octane fuel F2 containing the high-octane component by a large amount and having a higher octane number than that of the raw fuel F0 may be recovered from the low-pressure side of the separation film 21.

Meanwhile, the amount of the high-octane component contained in the raw fuel F0 flowing through the high-pressure chamber 22 is decreased toward the downstream side. Hence, the low-octane fuel F1 containing the high-octane component by a small amount and having a lower octane number than that of the raw fuel F0 remains in the high-pressure chamber 22. The low-octane fuel F1 flowing out of the separator 20 is cooled by the cooler 26, and then is supplied to the raw fuel tank 10.

Also, operation conditions of the separator 20, such as the temperature of the separation film 21, the temperature and supply amount of the raw fuel F0, the pressure of the high-pressure chamber 22, and the pressure (negative pressure) of the low-pressure chamber 24, are controlled. Accordingly, for example, the separation speed or recovery amount for the high-octane fuel F2 and the low-octane fuel F1 by the separator 20 are changed. Further, the pressure of the low-pressure chamber 24 is adjusted. The low-pressure chamber 24 communicates with the condenser 30 by reduction in pressure of the condenser 30.

For example, the temperature of the separation film 21 is adjusted when the temperature of the raw fuel F0 to be supplied to the separator 20 is adjusted by the heater 16. Also, the temperature of the separation film 21 is adjusted even when the flow rate of the raw fuel F0 to be supplied to the separator 20 is adjusted.

The separated low-octane fuel F1 flows along a low-octane fuel channel, passes through the cooler 26, and is returned to the raw fuel tank 10. Since the separated low-octane fuel F1 (for example, at about 75° C.) is cooled by the cooler 26, the temperature of the raw fuel F0 (for example, at about 50° C.) stored in the raw fuel tank 10 may be prevented from increasing.

The cooler (radiator) 26 cools the raw fuel F0 or the low-octane fuel F1, which is separated by the separator 20, by using a cooling fan 90, the air volume of which can be adjusted. The cooler 26 may be formed of a water cooling device in addition to or instead of the cooling fan 90.

Also, the cooling amount of the low-octane fuel F1 by the cooler 26 is adjusted by the air volume adjustment of the cooling fan 90.

The fuel supply device may further include a cooling device (not illustrated) for cooling the raw fuel tank 10.

The low-octane fuel F1 may be supplied to a low-octane fuel tank (not illustrated), which is different from the raw fuel tank 10, and then may be stored in the low-octane fuel tank. Also, the low-octane fuel F1 stored in the low-octane fuel tank may be supplied to the internal combustion engine 60 instead of the raw fuel F0.

The condenser (negative-pressure tank) 30 is provided in the middle of a recovery channel that connects the low-pressure chamber 24 of the separator 20 with the high-octane fuel tank 40. The condenser 30 condenses the high-octane fuel F2. The condenser 30 is formed of, for example, an air-cooling or water-cooling tank or reservoir.

The condenser 30 is connected with the suction side of a vacuum pump (negative-pressure pump) 36. The inside of the condenser 30 is controlled to have a negative pressure by the operation of the vacuum pump 36, and may have a lower pressure than the vapor pressure of the high-octane fuel F2. The vaporized fuel V containing alcohol, such as the high-octane component generated by the vaporization of the high-octane fuel F2, is supplied to the high-octane fuel tank 40 etc. by the operation of the vacuum pump 36. The condenser 30 is provided with a pressure sensor 73 for measuring the pressure of the inside of the condenser 30. The pressure sensor 73 outputs a signal corresponding to an internal pressure P of the condenser 30.

A first recovery channel FL1 that connects the separator 20 with the condenser 30 is provided with a first open/close mechanism 31 that opens and closes the channel. When the first open/close mechanism 31 is open, the low-pressure chamber 24 of the separator 20 communicates with the condenser 30. When the first open/close mechanism 31 is closed, the separator 20 is shut off from communication with the condenser 30.

A second recovery channel FL2 that connects the condenser 30 with the high-octane fuel tank 40 is provided with a second open/close mechanism 32 that opens and closes the channel. When the second open/close mechanism 32 is open, the condenser 30 communicates with the high-octane fuel tank 40. When the second open/close mechanism 32 is closed, the condenser 30 is shut off from communication with the high-octane fuel tank 40.

The condenser 30 is connected with the high-octane fuel tank 40 by a first vaporized fuel channel VL1, which is different from the second recovery channel FL2. The first vaporized fuel channel VL1 is provided with a third open/close mechanism 33 and the vacuum pump 36. When the third open/close mechanism 33 is open and the vacuum pump 36 is operated, the vaporized fuel V is introduced from the condenser 30 to the high-octane fuel F2 stored in the high-octane fuel tank 40.

The first vaporized fuel channel VL1 is connected with the high-octane fuel tank 40 through a second vaporized fuel channel VL2, which is branched from the upstream side of the vacuum pump 36. The second vaporized fuel channel VL2 is provided with a fourth open/close mechanism 34. When the third open/close mechanism 33 is open and the fourth open/close mechanism 34 is open, the vaporized fuel V filled in the high-octane fuel tank 40 is introduced to the condenser 30 through the second vaporized fuel channel VL2 and the first vaporized fuel channel VL1.

The high-octane fuel tank 40 stores the high-octane fuel F2, which is separated from the raw fuel F0 by the separator 20. The pressure of the high-octane fuel F2 stored in the high-octane fuel tank 40 is increased to a designated pressure by a high-pressure supply pump 42, and then the high-octane fuel F2 is supplied to the internal combustion engine 60.

When the high-octane fuel F2 stored in the high-octane fuel tank 40 is vaporized, the vaporized fuel V containing alcohol such as ethanol is generated. The high-octane fuel tank 40 is connected with the canister 50, and the connection channel therebetween is provided with a fifth open/close mechanism 35. When the fifth open/close mechanism 35 is open, the vaporized fuel V is supplied from the high-octane fuel tank 40 to the canister 50 through the connection channel.

The high-octane fuel tank 40 is provided with a pressure sensor (not illustrated) for measuring the internal pressure of the high-octane fuel tank 40. The open/close mechanisms 31 to 35 are formed of, for example, respective solenoid valves. The first vaporized fuel channel VL1 may be opened and closed by activation and deactivation of the vacuum pump 36, and hence the third open/close mechanism 33 for opening and closing the first vaporized fuel channel VL1 may be omitted.

The canister 50 contains an absorbent such as activated carbon. The absorbent absorbs the alcohol contained in the vaporized fuel V generated from the raw fuel F0, and the hydrocarbon. Accordingly, the vaporized fuel V may be separated into the alcohol and hydrocarbon, and other components such as nitrogen.

The air containing the separated nitrogen etc. is discharged from the canister 50 to the outside of the vehicle. Meanwhile, when the internal combustion engine 60 is operated and an inlet pipe 61 is brought into a negative pressure state, the alcohol and hydrocarbon absorbed by the absorbent in the canister 50 are supplied to the inlet pipe 61, introduced to a combustion chamber, and combusted. A discharge channel that is connected with the canister 50 is provided with a flow rate adjusting valve 52 for adjusting the flow rate of the vaporized fuel V in the discharge channel.

The canister 50 may be heated by heat of condensation of the high-octane fuel F2 generated in the condenser 30, and the temperature may be maintained within a temperature range that allows absorption performance for the vaporized fuel V to be sufficiently exhibited. For example, the channel of the medium may be formed so that the canister 50 is heated by the cooling medium of the condenser 30.

A reservoir, a heat exchanger, or a functional component, which is not explained or illustrated, may be provided in the middle of each channel.

The inlet pipe 61 connected with the combustion chamber of the internal combustion engine 60 is provided with an inlet valve 611, a fuel injection device 612, and a throttle valve 613. When the inlet valve 611 is open, the inlet pipe 61 communicates with the combustion chamber. When the inlet valve 611 is closed, the inlet pipe 61 is shut off from communication with the combustion chamber. The throttle valve 613 adjusts the intake air amount of the internal combustion engine 60.

The fuel injection device 612 is arranged between the inlet valve 611 and the throttle valve 613, and selectively injects one of the raw fuel F0 and the high-octane fuel F2 to each cylinder of the internal combustion engine 60. The fuel injection device 612 may simultaneously inject both the raw fuel F0 and the high-octane fuel F2 with a designated mixing ratio to each cylinder of the internal combustion engine 60. Alternatively, the fuel injection device 612 may inject the raw fuel F0 and the high-octane fuel F2 individually. Mixed gas of the air taken into the inlet pipe 61 and the fuel injected from the fuel injection device 612 is introduced from the inlet pipe 61 to the combustion chamber of each cylinder.

If the low-octane fuel tank is provided, the fuel injection device 612 may inject selectively one of the high-octane fuel F2 and the low-octane fuel F1, or simultaneously both the high-octane fuel F2 and the low-octane fuel F1 with a designated mixing ratio, to each cylinder of the internal combustion engine 60.

The inlet pipe 61 is provided with a turbocharger 65, a venturi gas mixer 651, and a purge pump 652 at the upstream side of the throttle valve 613. The vaporized fuel V may be supplied from the canister 50 to the inlet pipe 61 through the purge pump 652 and the turbocharger 65.

The internal combustion engine 60 may not be an engine with the turbocharger 65, and may be a natural aspiration engine. In this case, the vaporized fuel V may be supplied from the canister 50 to the inlet pipe 61 at the downstream side of the throttle valve 613 through a purge control valve (not illustrated).

Further, the vaporized fuel V may be directly supplied from the condenser 30 to the inlet pipe 61 by the venturi gas mixer 651. Also, the vaporized fuel V may be directly supplied from the high-octane fuel tank 40 to the inlet pipe 61 of the internal combustion engine 60.

The fuel supply device includes a first density sensor 71 at the downstream side of the separator 20 and the upstream side of the raw fuel tank 10, a second density sensor 72 in the high-octane fuel tank 40, and a fuel amount sensor 74 in the high-octane fuel tank 40.

The first density sensor 71 outputs a single corresponding to the density of the high-octane component in the low-octane fuel F1 separated from the raw fuel F0. The second density sensor 72 outputs a signal corresponding to the density of the high-octane component in the high-octane fuel F2 separated from the raw fuel F0. The fuel amount sensor 74 outputs a signal indicative of the stored amount of the high-octane fuel F2 in the high-octane fuel tank 40.

The control device 70 is formed of a programmable computer. The control device 70 receives output signals of various sensors for detecting various states of the fuel supply device, such as a signal output from the first density sensor 71, a signal output from the second density sensor 72, a signal output from the pressure sensor 73, a signal output from the fuel amount sensor 74. The control device 70 is programmed to execute arithmetic processing required for, for example, fuel injection control and ignition timing control of the internal combustion engine 60, adjustment for an activation condition of the separator 20, adjustment for fuel to be supplied to the internal combustion engine 60, operation control for each pump, and opening and closing or adjustment for the opening degree of each valve, in addition to “negative-pressure control processing” and “first separator-state determination processing” (described later).

For example, the control device 70 is programmed to start the fuel separation by the separator 20, by activating the high-pressure supply pump 12 if the density of the high-octane component in the low-octane fuel indicated by the signal output from the first density sensor 71 is higher than a predetermined value. Also, the control device 70 is programmed to end the fuel separation by the separator 20, by stopping the high-pressure supply pump 12 if the density of the high-octane component in the low-octane fuel F1 indicated by the signal output from the first density sensor 71 is lower than the predetermined value. Also, the control device 70 is programmed to determine the amount of the high-octane fuel F2 in the high-octane fuel tank 40 indicated by the signal output from the fuel amount sensor 74, to supply the low-octane fuel F1 and the high-octane fuel F2 to the internal combustion engine 60 with a proper ratio.

“Being programmed” represents that an arithmetic processing unit, such as a central processing unit (CPU), which is a component of the computer, reads software in addition to required information from a memory such as a read-only memory (ROM) or a random-access memory (RAM) or a recording medium, and executes arithmetic processing on the information according to the software.

The control device 70 forms a “state determination element” of this application.

### Basic Function

A function of the fuel supply device with the above-described configuration is described. In particular, the control device 70 repetitively executes the “negative-pressure control processing” according to a procedure described later. The description is given on a precondition that the fifth open/close mechanism 35 is closed.

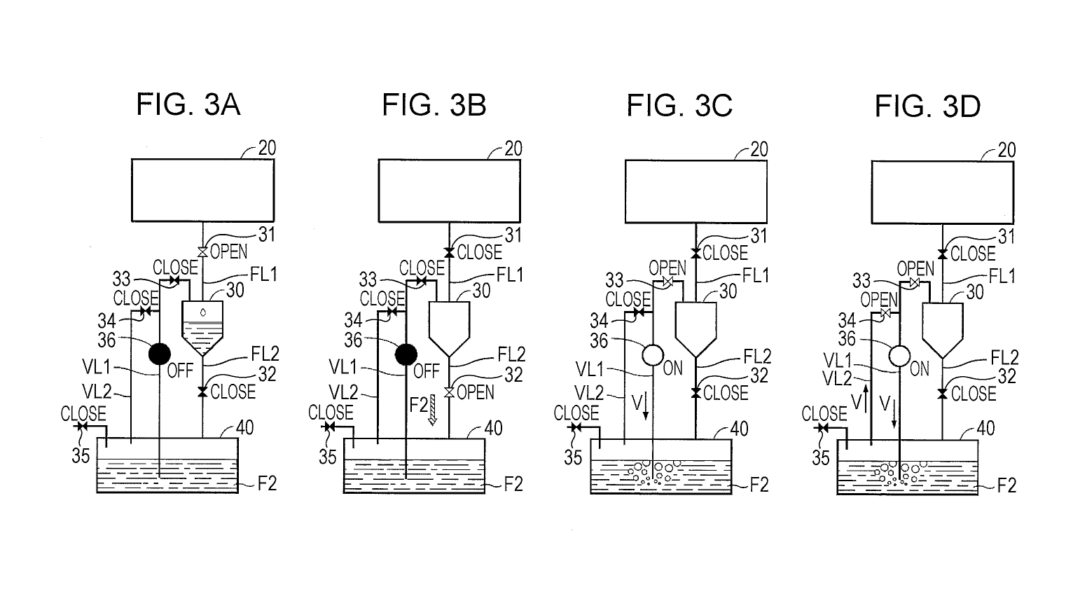

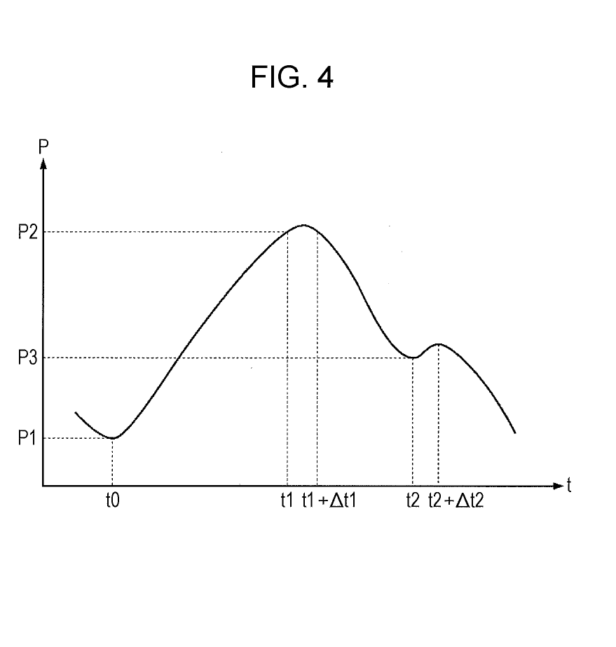

When the vacuum pump 36 is operated in a third state, the pressure of the condenser 30 is reduced, and the internal pressure P is gradually reduced (see t=t0 or before in FIG. 4). The “third state” represents that the first recovery channel FL1, the second recovery channel FL2, and the second vaporized fuel channel VL2 are closed, and the pressure of the condenser 30 is reduced by the operation of the vacuum pump 36 (see FIG. 3C). At this time, the third open/close mechanism 33 opens the first vaporized fuel channel VL1.

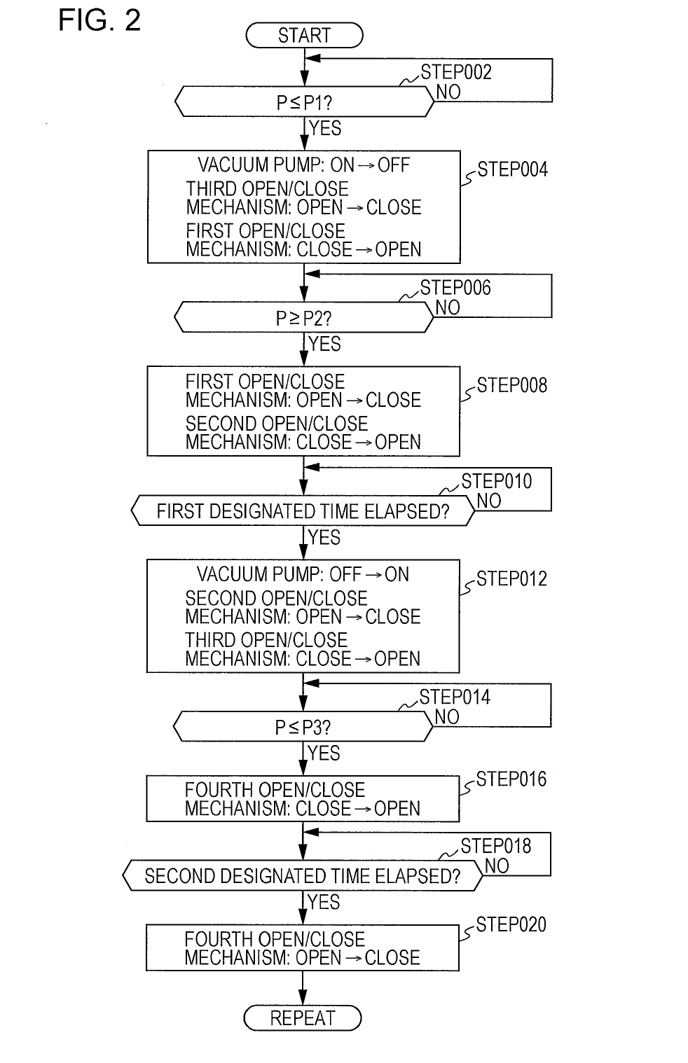

In this state, it is determined whether or not the internal pressure P of the condenser 30 becomes a first negative pressure P1 or less (STEP002 in FIG. 2). The “negative pressure” is defined as a negative value with reference to an atmospheric pressure or a normal pressure. That is, the absolute value increases as the pressure is lower than the atmospheric pressure.

If the determination result is positive (YES in STEP002 in FIG. 2 (see t=t0 in FIG. 4)), the first open/close mechanism 31 is switched from the closed state to the open state, the third open/close mechanism 33 is switched from the open state to the closed state, and the operation of the vacuum pump 36 is stopped (STEP004 in FIG. 2).

Accordingly, as illustrated in FIG. 3A, a “first state” is provided, in which the first recovery channel FL1 is open, the second recovery channel FL2 and the second vaporized fuel channel VL2 are closed, and the reduction in pressure of the condenser 30 by the operation of the vacuum pump 36 is stopped.

The transition requirement from the third state to the first state may not be defined by the internal pressure P of the condenser 30, and may be defined in accordance with an elapsed time since the transition from a second or fourth state to the third state is provided. For example, the transition from the third state to the first state may be provided on the basis of a requirement that the elapsed time is a designated time or longer.

In the first state, the separation of the high-octane fuel F2 and the low-octane fuel F1 is started by the separator 20, and the high-octane fuel F2 is supplied form the separator 20 to the condenser 30 through the first recovery channel FL1. At least part of the high-octane fuel F2 is condensed (phase is shifted from vapor phase to liquid phase) by the condenser 30 with a negative pressure in a cooled state, and then is reserved. Also, the vaporized fuel V is increased in the condenser 30, and the internal pressure P of the condenser 30 is increased (see t=t0 or later in FIG. 4).

It is determined whether or not the internal pressure P of the condenser 30 becomes a second negative pressure P2 or more, which is higher than the first negative pressure P1 (STEP006 in FIG. 2). Since the “negative pressure” is defined as a negative value with reference to the atmospheric pressure as described above, the absolute value of the second negative pressure P2 is smaller than the absolute value of the first negative pressure P1.

If the determination result is positive (YES in STEP006 in FIG. 2 (see t=t1 in FIG. 4)), the first open/close mechanism 31 is switched from the open state to the closed state, and the second open/close mechanism 32 is switched from the closed state to the open state (STEP008 in FIG. 2). Accordingly, as illustrated in FIG. 3B, the “second state” is provided, in which the first recovery channel FL1 and the second vaporized fuel channel VL2 are closed, the second recovery channel FL2 is opened, and the reduction in pressure of the condenser 30 by the operation of the vacuum pump 36 is stopped.

The transition requirement from the first state to the second state may not be defined by the internal pressure P of the condenser 30, and may be defined in accordance with an elapsed time since the transition from the third state to the first state is provided. For example, the transition from the first state to the second state may be provided on the basis of a requirement that the elapsed time is a designated time or longer.

The values of the first negative pressure P1 and the second negative pressure P2 may be previously changed to various values, and may be changed by the control device 70 in accordance with the fuel supply device or the travel state (acceleration request etc.) of the vehicle on which the fuel supply device is mounted. For example, the density or the content of the high-octane fuel F2 of the raw fuel F0 stored in the raw fuel tank 10 may be measured, and the second negative pressure P2 may be set higher as the measurement value is larger.

When the first open/close mechanism 31 closes the first recovery channel FL1 and the low-pressure chamber 24 of the separator 20 is shut off from communication with the condenser 30, the separation of the high-octane fuel FL2 and the low-octane fuel F1 from the raw fuel F0 by the separator 20 is stopped. When the second open/close mechanism 32 opens the second recovery channel FL2, the high-octane fuel F2 in liquid phase reserved in the condenser 30 is supplied to the high-octane fuel tank 40 through the second recovery channel FL2 (see downward arrow in FIG. 3B).

After the second state is provided, it is determined whether or not a first designated time Δt1 (for example, 10 [s]) has elapsed or not (STEP010 in FIG. 2).

If the determination result is positive (YES in STEP010 in FIG. 2 (t=t1+Δt1 in FIG. 4)), the second open/close mechanism 32 is switched from the open state to the closed state, the third open/close mechanism 33 is switched from the closed state to the open state, and the operation of the vacuum pump 36 is started (STEP012 in FIG. 2). Accordingly, the third state illustrated in FIG. 3C is provided.

In the third state, the vaporized fuel V (gas) is supplied from the condenser 30 to the high-octane fuel tank 40 through the first vaporized fuel channel VL1 (see downward arrow in FIG. 3C). The vaporized fuel V may cause bubbling of the high-octane fuel F2 in the high-octane fuel tank 40, and at least part of the vaporized fuel V in bubbles may be taken into the high-octane fuel F2 in liquid phase. In the high-octane fuel tank 40, the high-octane fuel F2 is in two phases (vapor phase and liquid phase), and the pressure of the high-octane fuel tank 40 is increased when the vaporized fuel V is supplied from the condenser 30.

The vaporized fuel V may be supplied from the condenser 30 to a spacer, in which the vaporized fuel V is similarly filled, in the high-octane fuel tank 40.

The internal pressure P of the condenser 30 is reduced by the operation of the vacuum pump 36 (see t=t1+Δt1 or later in FIG. 4). Now, it is determined whether or not the internal pressure P of the condenser 30 becomes a third negative pressure P3 or less, the third negative pressure P3 being higher than the first negative pressure P1 and being lower than the second negative pressure P2 (STEP014 in FIG. 2).

If the determination result is positive (YES in STEP014 in FIG. 2 (see t=t2 in FIG. 4)), the fourth open/close mechanism 34 is switched from the closed state to the open state (STEP016 in FIG. 2). Accordingly, as illustrated in FIG. 3D, a “fourth state” is provided, in which the first recovery channel FL1 and the second recovery channel FL2 are closed, the second vaporized fuel channel VL2 is open, and the pressure of the condenser is reduced by the operation of the vacuum pump 36.

Alternatively, the transition from the third state to the fourth state may be provided on the basis of a requirement that a reduction speed of the internal pressure P|dP/dt| becomes a predetermined speed or lower, instead of that the internal pressure P of the condenser 30 becomes the third negative pressure or less, the third negative pressure P3 being higher than the first negative pressure P1 and being lower than the second negative pressure P2.

In the fourth state, the vaporized fuel V is supplied from the high-octane fuel tank 40 to the condenser 30 through the second vaporized fuel channel VL2 (see upward arrow in FIG. 3D), and hence the internal pressure P of the condenser 30 is increased (see t=t2 or later in FIG. 4).

After the fourth state is provided, it is determined whether or not a second designated time Δt2 (for example, 10 [s], the second designated time Δt2 may be the same as the first designated time Δt1, or may be different) (STEP018 in FIG. 2).

If the determination result is positive (YES in STEP018 in FIG. 2 (see t=t2+Δt2 in FIG. 4)), the fourth open/close mechanism 34 is switched from the open state to the closed state (STEP020 in FIG. 2). Accordingly, the third state is provided again, and the internal pressure P of the condenser 30 is shifted from increase to reduction (see t=t2+Δt2 or later in FIG. 4).

Thereafter, the above-described series of processing is repeated (see STEP002 to STEP020 in FIG. 2).

Also, the control device 70 determines whether or not a release condition of the high-octane fuel tank 40 is satisfied during execution of the negative-pressure control processing. The “release condition” may be a condition that the measured pressure of the high-octane fuel tank 40 becomes a threshold or higher, a condition that an acceleration request of the vehicle exceeding a threshold is made, or a combination of these conditions.

Then, if it is determined that the release condition is satisfied, the fifth open/close mechanism 35 is switched from the closed state to the open state, and a “fifth state” is provided, in which the channel that connects the high-octane fuel tank 40 with the canister 50 is open. At this time, for example, the first open/close mechanism 31, the second open/close mechanism 32, the third open/close mechanism 33, and the fourth open/close mechanism 34 are controlled to be in the closed state. In the fifth condition, the vaporized fuel V is released from the high-octane fuel tank 40, is absorbed by the canister 50, and is supplied to the internal combustion engine 60 through the inlet pipe 61 as necessary. The vaporized fuel V may be directly supplied to the internal combustion engine 60. Accordingly, utilization efficiency of the vaporized fuel V is increased.

With the “negative-pressure control processing,” the high-octane fuel F2 separated by the separator 20 in vapor phase (in the form of vaporized fuel) is supplied from the separator 20 to the condenser 30 through the first recovery channel FL1, and at least part of the high-octane fuel F2 is condensed by the condenser 30 and hence is reserved in liquid phase.

Then, in the second state (the first recovery channel FL1: closed, the second vaporized fuel channel VL2: closed, the second recovery channel FL2: open, the condenser 30: reduction in pressure being stopped), the high-octane fuel F2 in liquid phase is supplied from the condenser 30 to the high-octane fuel tank 40 through the second recovery channel FL2 (see STEP008 in FIG. 2, FIG. 3B).

Further, in the third state (the first recovery channel FL1: closed, the second recovery channel FL2: closed, the second vaporized fuel channel VL2: closed, the condenser 30: pressure being reduced), the vacuum pump 36 is operated. Accordingly, the vaporized fuel V is supplied from the condenser 30 to the high-octane fuel tank 40 through the first vaporized fuel channel VL1 (see STEP012 in FIG. 2, FIG. 3C).

At this time, the internal pressure P of the condenser 30 is reduced (see t=t1+Δt1 to t2 in FIG. 4). The phase of at least part of the vaporized fuel V is transited from the vapor phase to the liquid phase, and the fuel in the liquid phase may be stored in the high-octane fuel tank 40 as the high-octane fuel F2. As described above, since the vaporized fuel V is prevented from being discharged to the outside of the vehicle in a non-recoverable or non-usable form when the pressure of the condenser 30 is reduced, the utilization efficiency of the vaporized fuel V is increased.

Alternatively, the “negative-pressure control processing” may not be employed, and the vaporized fuel V may be discharged to the outside of the vehicle.

### First Separator-State Determination Processing

The control device 70 repetitively execute “first separator-state determination processing” as described below.

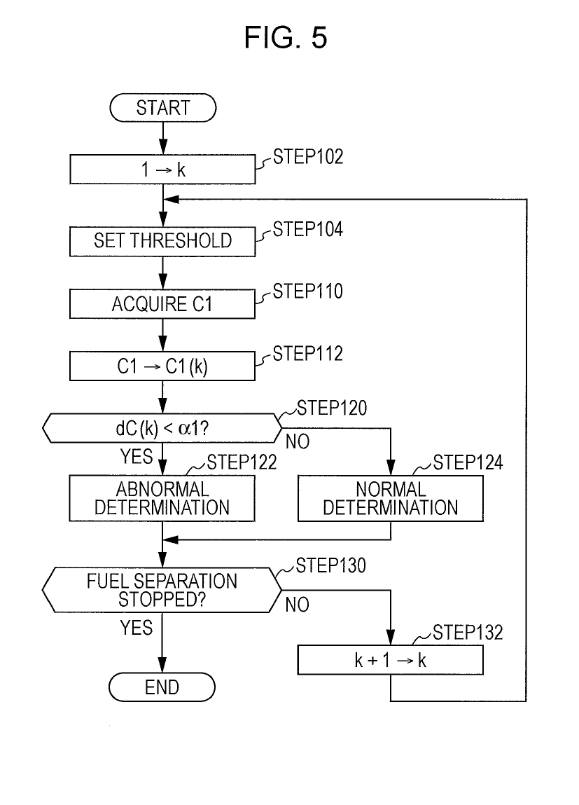

When the “first separator-state determination processing” is started, the control device 70 sets the value of a number control variable k at 1 (STEP102 in FIG. 5). Also, the control device 70 sets a density threshold α1 based on the temperature of the separator 20 acquired from a separator temperature sensor (not illustrated) (STEP104 in FIG. 5). If the temperature of the separator 20 is within a previously stored proper temperature range, the high-octane component separated from the raw fuel F0 is increased, and hence the difference (first density variation) between a current value and a previous value of a first density C1, which is the density of the high-octane component in the low-octane fuel F1, is increased. Hence, the control device 70 preferably sets the density threshold α1 at a high value.

Then, when the fuel separation progresses, a density C0 of the high-octane component in the raw fuel F0 is decreased, resulting in a saturated state. In this case, the control device 70 preferably sets the density threshold α1 at a low value.

Also, the control device 70 measures the first density C1 by using an output signal from the first density sensor 71 (STEP110 in FIG. 5). Then, the control device 70 holds the measured first density C1 as a current first density C1(k) in the storage device (not illustrated) (STEP112 in FIG. 5).

Then, the control device 70 calculates the difference between the current first density C1(k) and the previous first density C1(k−1) as a first density variation dC(k), and determines whether or not the first density variation dC(k) is smaller than the density threshold α1 (STEP120 in FIG. 5).

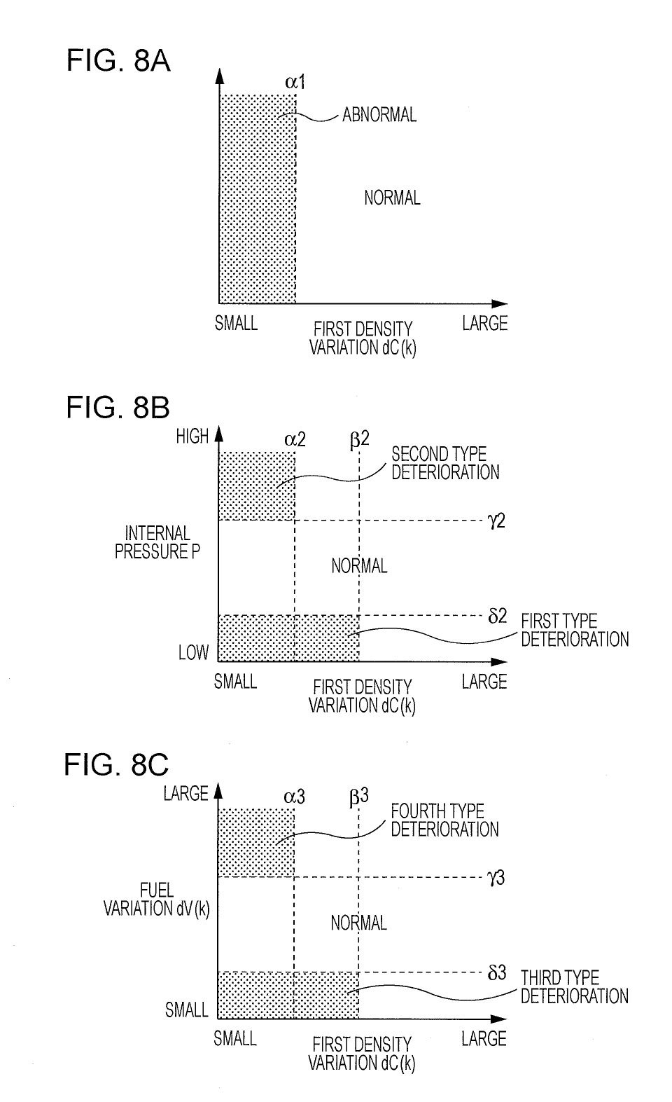

If the determination result is positive (YES in STEP120 in FIG. 5), the control device 70 determines that an abnormality occurs in the separator 20 (STEP122 in FIG. 5). If the first density variation dC(k) is smaller than the predetermined density threshold α1, the performance of the separator 20 may be deteriorated, and hence it may be considered that an abnormality occurs in the separator 20 (see FIG. 8A).

In contrast, if the determination result is negative (NO in STEP120 in FIG. 5), the control device 70 determines that an abnormality does not occur in the separator 20 (the separator 20 being normal) (STEP124 in FIG. 5).

After the processing in STEP122 or STEP124 in FIG. 5, the control device 70 checks whether or not the fuel separation processing is stopped (STEP130 in FIG. 5). If the determination result is positive (YES in STEP130 in FIG. 5), the control device 70 ends the “first separator-state determination processing.” If the determination result is negative (NO in STEP130 in FIG. 5), the control device 70 increments the number control variable k by 1 (STEP132 in FIG. 5), and then repeats the processing from STEP104 in FIG. 5.

### Effect and Advantage of First Separator-State Determination Processing

With this embodiment, if the first density variation dC(k) is smaller than the predetermined threshold α1 (YES in STEP120 in FIG. 5), the control device 70 determines that the separator 20 is abnormal (see STEP122 in FIG. 5, FIG. 8A), and if the first density variation dC(k) is equal to or larger than the predetermined threshold α1 (NO in STEP120 in FIG. 5), the control device 70 determines that the separator 20 is normal (see STEP124 in FIG. 5, FIG. 8A). Accordingly, the state of the separator 20 is determined with high accuracy. Also, since the first density sensor 71, which is used for determining whether the fuel separation processing is started or ended, is also used for the control of the “first separator-state determination processing,” the fuel supply device is simplified.

### Second Separator-State Determination Processing

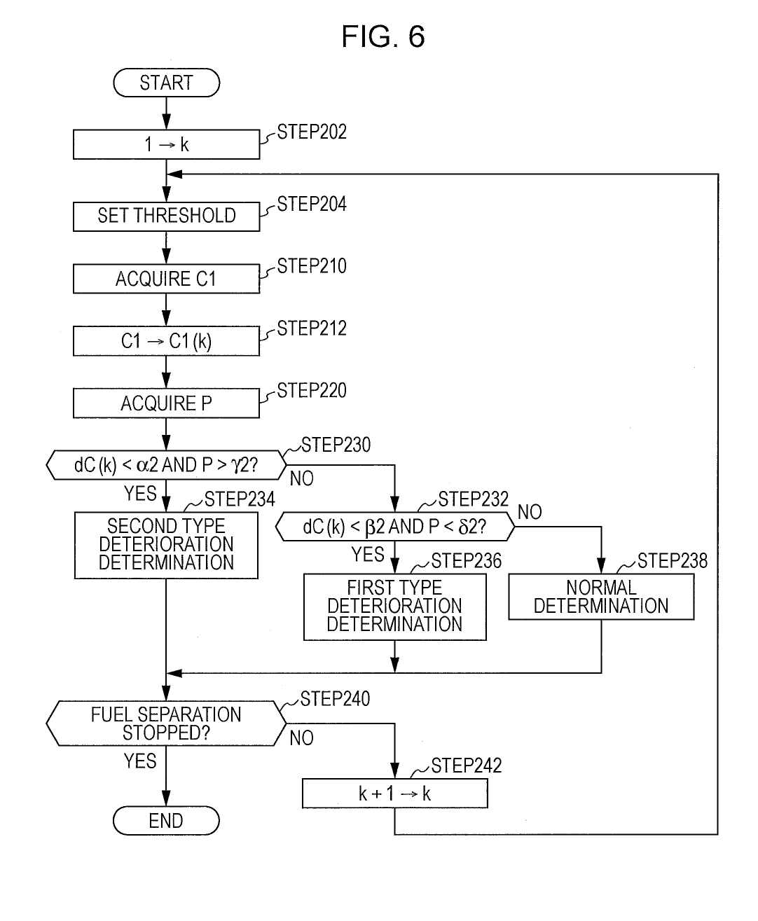

The control device 70 may repetitively execute “second separator-state determination processing” instead of the “first separator-state determination processing.” Also, pressure acquisition in the “second separator-state determination processing” (STEP220 in FIG. 6) is preferably executed in the “first state (see FIG. 3A)”, in which the separator 20 communicates with the condenser 30, in the “negative-pressure control processing.”

In the “second separator-state determination processing,” the state of the separator 20 is classified into a normal state, a first type deterioration state in which the separation performance is decreased and the negative pressure of the low-pressure chamber 24 is maintained (for example, clogging of the separation film 21 caused by flowing of an impurity solid inevitably contained in the raw fuel F0), and a second type deterioration state in which the separation performance is decreased and it is difficult to maintain the negative pressure of the low-pressure chamber 24 (for example, fracture of the separation film 21, such as structural disorder of the separation film 21), and then makes the determination.

When the “second separator-state determination processing” is started, the control device 70 sets the number control variable k at 1 (STEP202 in FIG. 6), and sets a density threshold α2, a density threshold β2, a pressure threshold γ2, and a pressure threshold δ2 (where γ2>δ2) based on the temperature of the separator 20 acquired from the separator temperature sensor (not illustrated), and the first density C1 of the high-octane component in the low-octane fuel F1 acquired from the first density sensor 71 (STEP204 in FIG. 6).

The control device 70 measures the first density C1 through the first density sensor 71 (STEP210 in FIG. 6), and holds the first density C1 as a current first density C1(k) in the storage device (not illustrated) (STEP212 in FIG. 6). Then, the control device 70 measures the internal pressure P of the condenser 30 through the pressure sensor 73 (STEP220 in FIG. 6).

Then, the control device 70 determines whether or not the first density variation dC(k) being the difference between the current first density C1(k) and the previous first density C1(k−1) is smaller than the density threshold α2, and the internal pressure P exceeds the pressure threshold γ2 (STEP230 in FIG. 6).

If the determination result is positive (YES in STEP230 in FIG. 6), the control device 70 determines that the separator 20 is in the second type deterioration state (see STEP234 in FIG. 6, FIG. 8B). The condenser 30 (the low-pressure chamber 24) is not maintained with the negative pressure, the first density variation dC(k) is smaller than the predetermined value (the fuel separation is not executed in an expected manner), and hence it may be determined that the separator 20 (or the separation film 21) is in the second type deterioration state.

If the determination result is negative (NO in STEP230 in FIG. 6), the control device 70 determines whether or not the first density variation dC(k) is smaller than the density threshold β2, and the internal pressure P is lower than the pressure threshold δ2 (STEP232 in FIG. 6). If the determination result is positive (YES in STEP232 in FIG. 6), the control device 70 determines that the separator 20 is in the first type deterioration state (see STEP236 in FIG. 6, FIG. 8B). Although the condenser 30 (the low-pressure chamber 24) is maintained with the negative pressure, the first density variation dC(k) is smaller than the predetermined value (the fuel separation is not executed in an expected manner), and hence it may be determined that the separator 20 (or the separation film 21) is in the first type deterioration state.

If the determination result is negative (NO in STEP232 in FIG. 6), the control device 70 determines that the separator 20 is normal (see STEP238 in FIG. 6, FIG. 8B).

After the processing in any of STEP234 to STEP238 in FIG. 6, the control device 70 checks whether or not the fuel separation processing is stopped (STEP240 in FIG. 6). If the determination result is positive (YES in STEP240 in FIG. 6), the control device 70 ends the “second separator-state determination processing.” If the determination result is negative (NO in STEP240 in FIG. 6), the control device 70 increments the number control variable k by 1 (STEP242 in FIG. 6), and then repeats the processing from STEP204 in FIG. 6.

### Effect and Advantage of Second Separator-State Determination Processing

With the “second separator-state determination processing,” determination can be made whether the separator 20 is in the normal state, the first type deterioration state, or the second type deterioration state in accordance with the first density C1 and the internal pressure P. Hence, the state of the separator 20 can be determined with further high accuracy. Also, the pressure sensor 73 used for the “negative-pressure control processing” is also used for the control of the “second separator-state determination processing,” the fuel supply device is simplified.

### Third Separator-State Determination Processing

The control device 70 may repetitively execute “third separator-state determination processing” instead of the “first separator-state determination processing.”

In the “third separator-state determination processing,” the state of the separator 20 is classified into a normal state, a third type deterioration state in which the separation performance is decreased and the amount of separated fuel is small (for example, clogging of the separation film 21 caused by flowing of an impurity solid inevitably contained in the raw fuel F0), and a fourth type deterioration state in which the separation performance is decreased although the amount of separated fuel is large (for example, fracture of the separation film 21, such as structural disorder of the separation film 21), and then makes the determination.

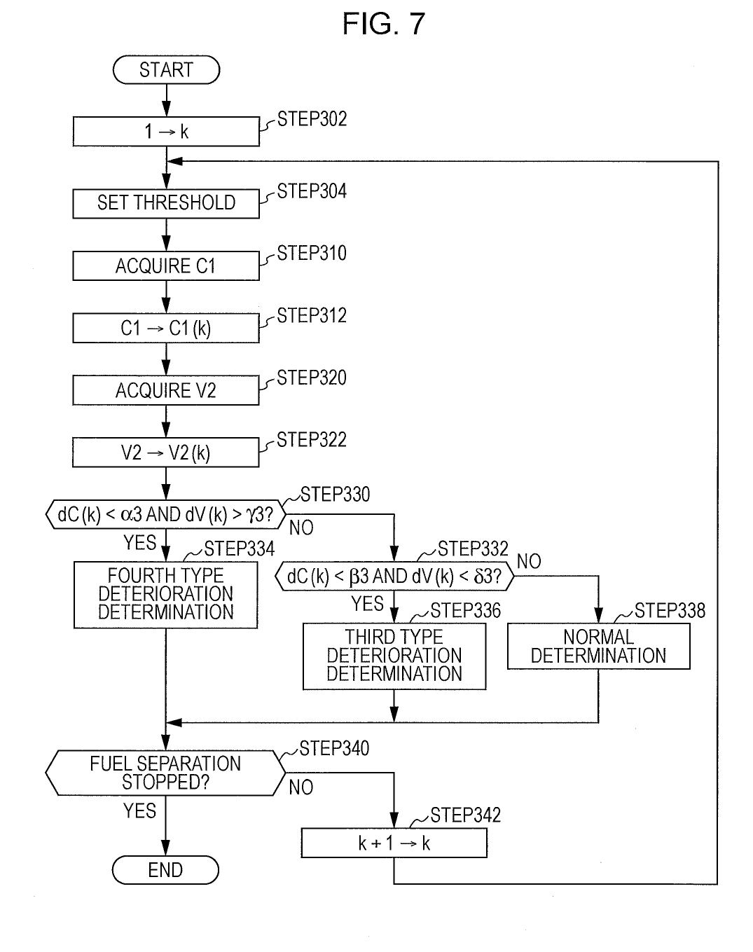

When the “third separator-state determination processing” is started, the control device 70 sets the number control variable k at 1 (STEP302 in FIG. 7), and sets a density threshold α3, a density threshold β3, a fuel amount threshold γ3, and a fuel amount threshold δ3 (where, γ3>δ3) based on the temperature of the separator 20 acquired from the separator temperature sensor (not illustrated) and the first density C1 acquired from the first density sensor 71 (STEP304 in FIG. 7).

Please add setting examples of thresholds based on the temperature and the density.

The control device 70 measures the first density C1 through the first density sensor 71 (STEP310 in FIG. 7), and holds the first density C1 as a current first density C1(k) in the storage device (not illustrated) (STEP312 in FIG. 7). Also, the control device 70 measures a fuel amount V2 of the high-octane fuel F2 in the high-octane fuel tank 40 through the fuel amount sensor 74 (STEP320 in FIG. 7), and holds the fuel amount V2 as a current fuel amount V2(k) in the storage device (not illustrated) (STEP322 in FIG. 7).

Then, the control device 70 determines whether or not a first density variation dC(k) being the difference between the current first density C1(k) and a previous first density C1(k−1) is smaller than the density threshold α3, and a fuel variation dV(k) being the difference between the current fuel amount V2(k) and a previous fuel amount V2(k−1) exceeds the fuel amount threshold γ3 (STEP330 in FIG. 7).

If the determination result is positive (YES in STEP330 in FIG. 7), the control device 70 determines that the separator 20 is in the fourth type deterioration state (see STEP334 in FIG. 7, FIG. 8C). Although the first density variation dC(k) is smaller than the predetermined value (the fuel separation is not executed in an expected manner), the fuel amount V2 in the high-octane fuel tank 40 is increased, and hence it may be determined that the separator 20 is in the fourth type deterioration state.

If the determination result is negative (NO in STEP330 in FIG. 7), the control device 70 determines whether or not the first density variation dC(k) is smaller than the density threshold β3, and the fuel variation dV(k) is smaller than the fuel amount threshold δ3 (STEP332 in FIG. 7).

If the determination result is positive (YES in STEP332 in FIG. 7), the control device 70 determines that the separator 20 is in the third type deterioration state (see STEP336 in FIG. 7, FIG. 8C). The first density variation dC(k) is smaller than the predetermined value (the fuel separation is not executed in an expected manner), the fuel amount V2 in the high-octane fuel tank 40 is not increased, and hence it may be determined that the separator 20 is in the third type deterioration state.

If the determination result is negative (NO in STEP332 in FIG. 7), the control device 70 determines that the separator 20 is normal (see STEP338 in FIG. 7, FIG. 8C).

After the processing in any of STEP334 to STEP338 in FIG. 7, the control device 70 checks whether or not the fuel separation processing is stopped (STEP340 in FIG. 7). If the determination result is positive (YES in STEP340 in FIG. 7), the control device 70 ends the “third separator-state determination processing.” If the determination result is negative (NO in STEP340 in FIG. 7), the control device 70 increments the number control variable k by 1 (STEP342 in FIG. 7), and then repeats the processing from STEP304 in FIG. 7. Effect and Advantage of Third Separator-state Determination Processing

With the “third separator-state determination processing,” it can be determined whether the separator 20 is in the normal state, in the third type deterioration state, or in the fourth type deterioration state in accordance with the first density variation dC(k) and the fuel variation dV(k), and hence the state of the separator 20 can be further highly accurately determined. Also, since the fuel amount sensor 74, which is also used for the fuel supply control to the turbocharger 65, is also used for the control of the “third separator-state determination processing,” the fuel supply device can be simplified.

### Modification

The arrangement position of the first density sensor 71 is not limited to the downstream side of the separator 20 and the upstream side of the raw fuel tank 10, and may be the downstream side of the raw fuel tank 10 and the upstream side of the separator 20 (the raw fuel channel FL0 in FIG. 1), or in the supply channel of the raw fuel F0 to the internal combustion engine 60. However, in the viewpoint of determining the state of the separator 20 with higher accuracy, the first density sensor 71 is preferably arranged at the downstream side of the separator 20 and the upstream side of the raw fuel tank 10.

The arrangement position of the second density sensor 72 is not limited to the inside of the high-octane fuel tank 40, and may be at the downstream side of the separator 20 and the upstream side of the high-octane fuel tank 40, or in the supply channel to the internal combustion engine 60.

In the “second separator-state determination processing,” the state of the separator 20 is determined on the basis of the signal output from the pressure sensor 73 arranged in the condenser 30. Instead of this, the state of the separator 20 may be determined on the basis of the signal output from a pressure sensor etc. installed in the low-pressure chamber 24.

In the “third separator-state determination processing,” the fuel amount sensor 74 is installed in the high-octane fuel tank 40; however, the fuel amount sensor 74 may be arranged at any position as long as the fuel amount (or the variation) of the high-octane fuel F2 can be recognized by using the output signal of the fuel amount sensor 74. For example, the fuel amount sensor 74 may be arranged at the downstream side of the separator 20 and the upstream side of the condenser 30.

If the low-octane fuel tank is provided separately from the raw fuel tank 10, instead of that the control device 70 determines whether or not the “first density variation dC(k) is smaller than the predetermined density threshold α1 (STEP120 in FIG. 5), a configuration may be provided, in which “it is determined whether or not the first density C1 of the high-octane component in the low-octane fuel F1 is a predetermined density threshold α1′ or higher.” This configuration considers that, if the first density C1 is the predetermined density threshold α1′ or higher, there is a high possibility that the state of the separator 20 is abnormal. This configuration is similarly applied to the “second separator-state determination processing” and the “third separator-state determination processing.”

Also, in the “first separator-state determination processing” to the “third separator-state determination processing,” the abnormality of the separator 20 is determined based on whether or not the first density variation dC(k) is smaller than the predetermined value. Instead of the processing, the state of the separator 20 may be determined on the basis of the tendency of the density for several times in the past (e.g., the rate of change of the density over time).

Further, in the “second separator-state determination processing” and the “third separator-state determination processing,” the state of the separator 20 is determined. At this time, not two states but only one state of the separator 20 may be determined, such as determination on whether or not the state of the separator 20 is the first type deterioration state, or whether or not the state of the separator 20 is the third type deterioration state.

Also, in the “first separator-state determination processing” to the “third separator-state determination processing,” each parameter is compared with a predetermined threshold. Instead of this, the state of the separator 20 may be determined in accordance with the result of a predetermined expression, such as a linear expression of a plurality of parameters.

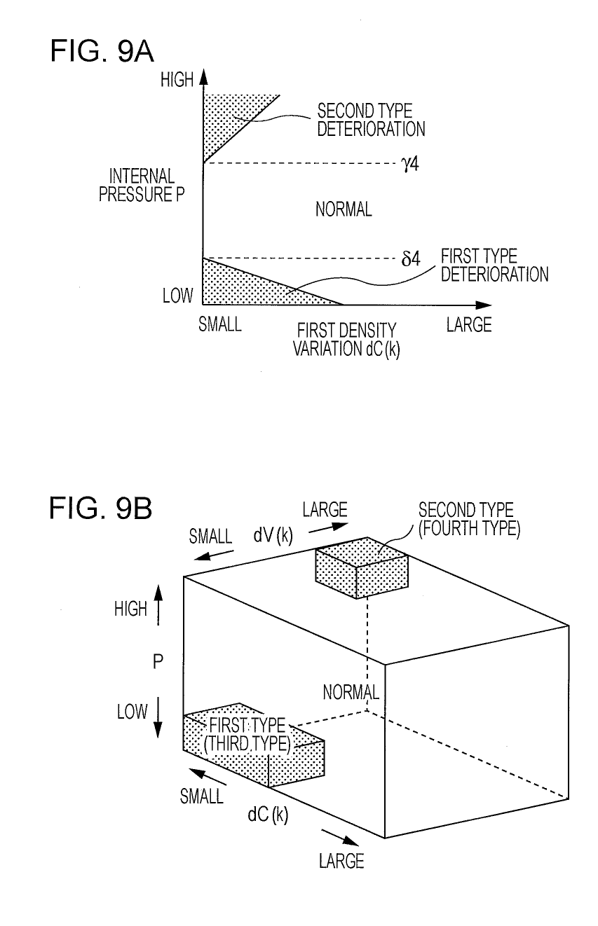

For example, the control device 70 may determine that the separator 20 is in the second type deterioration state if the first density variation dC(k), the internal pressure P, and the thresholds γ4 and δ4 satisfy Expression (1), the separator 20 is in the first type deterioration state if the values do not satisfy Expression (1) but satisfy Expression (2), and the separator 20 is normal if the values do not satisfy Expression (1) or Expression (2) (see FIG. 9A). Expression (1) and Expression (2) are as follows:

P>dC+γ4 (1),

and

P<δ4−dC*(½) (2).

Also, the “first separator-state determination processing” to the “third separator-state determination processing” respectively use only the first density variation dC(k), the first density variation dC(k) and the internal pressure P, and the first density variation dC(k) and the fuel variation dV(k), as the criteria for the determination on the state of the separator 20. Instead of this, the control device 70 may be configured that the first density variation dC(k) and at least one of the internal pressure P, the fuel variation dV(k), and a second density C2 of the high-octane component in the high-octane fuel F2 serve as criteria for the determination on the state of the separator 20.

For example, the control device 70 may be configured that the separator 20 is determined as being in the first type or third type deterioration state if the first density variation dC(k) is a predetermined density threshold α5 or smaller, the internal pressure P is a predetermined pressure threshold γ5 or lower, and the fuel variation dV(k) is a predetermined fuel amount threshold δ5 or smaller; the separator 20 is determined as being in the second type or fourth type deterioration state if the first density variation dC(k) is a predetermined density threshold α5′ or smaller, the internal pressure P is a predetermined pressure threshold γ5′ or higher, and the fuel variation dV(k) is a predetermined fuel amount threshold δ5′ or larger; and otherwise, the separator 20 is determined as being normal (see FIG. 9B).

Also, the control device 70 may be configured that the state is determined as being abnormal if the first density variation dC(k) is a predetermined density threshold α6 or smaller and the second density C2 is a predetermined threshold β6 or lower; and the state is determined as being normal if the first density variation dC(k) is the predetermined threshold α6 or larger or the second density C2 is the predetermined threshold β6 or higher. With this configuration, the state of the separator 20 may be further highly accurately determined.

Further, in this embodiment, the control device 70 uses the first density variation dC(k), or the first density variation dC(k) and the pressure P or the fuel variation dV(k) serve as the criterion for the determination on the state of the separator 20. Alternatively or additionally, the first density C1, the current pressure P(k), the pressure variation dP(k), which is the difference between the current pressure P(k) and the previous pressure P(k−1), the fuel amount V2, and the second density C2 or a second density variation dC2(k), which is the difference between the current second density and the previous second density may serve as criteria for the determination on the state of the separator 20.

For example, the control device 70 may determine the separator 20 as being abnormal if the first density C1 is high and determine the separator 20 as being normal if the first density C1 is low. Also, the control device 70 may determine the separator 20 as being in the first type deterioration state if the first density C1 is high and the pressure variation dP(k) is large, and may determine the separator 20 as being in the second type deterioration state if the first density C1 is high and the pressure variation dP(k) is small. Further, the control device 70 may determine the separator 20 as being in the third type deterioration state if the first density C1 is high and the fuel amount V2 is small, and may determine the separator 20 as being in the fourth type deterioration state if the first density C1 is high and the fuel amount V2 is large. Further, the control device 70 may determine the separator 20 as being abnormal if the first density C1 is high and the second density variation dC2(k) is small, and may determine the separator 20 as being normal if the first density C1 is low and the second density variation dC2(k) is small.

Also, in this embodiment, the control device 70 determines the separator 20 as being abnormal if the first density variation dC(k) is smaller than the predetermined threshold. However, the control device 70 may determine the separator 20 as having a higher degree of abnormality if the first density variation dC(k) is smaller. Additionally or alternatively, the control device 70 may determine the separator 20 as having a higher degree of abnormality if the first density C1 is higher.

A fuel separation device according to an aspect of the embodiment includes a raw fuel tank that stores raw fuel; a separator that separates the raw fuel supplied from the raw fuel tank into high-octane fuel, which contains a high-octane component by a larger amount than an amount of the high-octane component in the raw fuel, and low-octane fuel, which contains the high-octane component by a smaller amount than the amount of the high-octane component in the raw fuel; a first density sensor that outputs a signal corresponding to a density of the high-octane component in the low-octane fuel; and a state determination element that determines a state of the separator in accordance with the density of the high-octane component indicated by the signal output from the first density sensor.

With the configuration of the embodiment, with regard to that a change in separation performance of the separator is reflected on the density of the high-octane component in the low-octane fuel, the density serves as a criterion for the determination on the state of the separator. Accordingly, the accuracy of the determination is maintained or increased.

Also, if the fuel separation device includes a sensor that outputs a signal indicative of the density to determine a progress state of fuel separation processing in accordance with the degree of the density of the high-octane component in the low-octane fuel, the above described sensor may also serve as the first density sensor. Accordingly, the number of parts in the entire device can be decreased, and hence the fuel separation device can be simplified.

According to the aspect of the embodiment, the separator may preferably include a separation film that selectively transmits the high-octane component contained in the raw fuel, and a high-pressure chamber and a low-pressure chamber partitioned by the separation film. The fuel separation device may preferably further include a pressure sensor that outputs a signal corresponding to a pressure of the low-pressure chamber. The state determination element may preferably use the pressure indicated by the signal output from the pressure sensor as a criterion for the determination on the state of the separator.

In the configuration of the embodiment, the high-pressure chamber is a chamber to which the raw fuel is supplied, and the low-pressure chamber is a chamber in which a negative pressure is provided because the chamber is vacuumed by a vacuum pump or the like during the fuel separation.

With the configuration of the embodiment, since the pressure indicated by the signal output from the pressure sensor serves as the criterion for the determination on the state of the separator, the state of the separator, which may not be determined only with the density of the high-octane component, is further accurately determined.

For example, the determination is made at least with discrimination between a “first type deterioration state” in which the fuel separation performance is decreased although the negative pressure of the low-pressure chamber is maintained sufficiently low in a viewpoint of separation of the fuel and a “second type deterioration state” in which the negative pressure of the low-pressure chamber is not maintained within a desirable range in the viewpoint of the separation of the fuel and the fuel separation performance is also decreased. Accordingly, for example, further proper maintenance can be provided for the fuel separation device.

Also, if a sensor that measures a pressure of the low-pressure chamber (or a component having an internal pressure substantially equivalent to the pressure of the low-pressure chamber, such as a device communicating with the low-pressure chamber) is used to control the fuel separation function of the separator, the sensor also serves as the pressure sensor, the number of parts of the entire fuel separation device can be decreased, and hence the fuel separation device can be simplified.

According to the aspect of the embodiment, the fuel separation device may preferably further include a high-octane fuel tank that accumulates the high-octane fuel; and a fuel amount sensor that outputs a signal corresponding to an amount of the high-octane fuel accumulated in the high-octane fuel tank. The state determination element uses the amount of the high-octane fuel indicated by the signal output from the fuel amount sensor as a criterion for the determination on the state of the separator.

With the configuration of the embodiment, since the fuel amount indicated by the signal output from the fuel amount sensor serves as the criterion for the determination on the state of the separator, the state of the separator, which is not determined only with the density of the high-octane component, is further accurately determined.

For example, with the configuration of the embodiment, the determination is made with discrimination between a “third type deterioration state” in which the fuel separation performance is decreased and the amount of the separated fuel is small and a “fourth type deterioration state” in which the fuel separation performance is decreased although the amount of the separated fuel is large. Hence, the state of the separator is further accurately determined. Since the state of the separator is accurately determined with the above discrimination, for example, more proper maintenance is available for the fuel separation device.

Also, if a sensor that measures an amount of the high-octane fuel in the high-octane fuel tank is provided in order to supply the low-octane fuel and the high-octane fuel with a proper mixing ratio to an internal combustion engine, if the sensor also serves as the fuel amount sensor, the number of parts can be decreased, and hence the fuel separation device can be simplified.

According to the aspect of the embodiment, the fuel separation device may preferably further include a second density sensor that outputs a signal corresponding to a density of the high-octane component in the high-octane fuel. The state determination element may preferably use the density of the high-octane component in the high-octane fuel indicated by the signal output from the second density sensor as a criterion for the determination on the state of the separator.

With the configuration of the embodiment, since the sensor used for other purpose also serves as the first density sensor or the second density sensor as described above, the entire fuel separation device can be simplified. Also, since the density of the high-octane component in the high-octane fuel in addition to the density of the high-octane component in the low-octane fuel serve as the criteria for the determination on the state of the separator, the state of the separator can be further accurately determined.

According to the aspect of the embodiment, the raw fuel tank may preferably accumulate the low-octane fuel, and the first density sensor may preferably output a signal indicative of a density of the high-octane component in the raw fuel or the low-octane fuel.

If the low-octane fuel is stored in the raw fuel tank in the device, the low-octane fuel is mixed with the raw fuel in the raw fuel tank, and new raw fuel in a mixed manner is formed. The density of the high-octane component in the low-octane fuel relates to the state of the separator as described above. Hence, the density of the high-octane component in the new raw fuel formed by mixing the low-octane fuel and the raw fuel relates to the state of the separator, for example, such that a variation in density is decreased if an abnormality occurs in the separator. Accordingly, in the device, the state of the separator can be determined in accordance with the density of the high-octane component in the low-octane fuel or the raw fuel.

With the configuration of the embodiment, in addition to the aforementioned advantages, since the number of parts can be decreased because the raw fuel tank stores the low-octane fuel, the fuel separation device can be simplified. Also, since the arrangement position of the first density sensor can be selected from a variety of choices, the use of the first density sensor for an additional purpose is increased, and the device can be more flexibly formed.

Obviously, numerous modifications and variations of the present invention are possible in light of the above teachings. It is therefore to be understood that within the scope of the appended claims, the invention may be practiced otherwise than as specifically described herein.

What is claimed is:

1. A fuel separation device comprising:
a raw fuel tank to store raw fuel;
a separator to separate the raw fuel supplied from the raw fuel tank into high-octane fuel and low-octane fuel, the high-octane fuel containing a high-octane component by a larger amount than an amount of a high-octane component in the raw fuel, the low-octane fuel containing a high-octane component by a smaller amount than the amount of the high-octane component in the raw fuel;
a first density sensor configured to output a signal corresponding to a density of the high-octane component contained in the low-octane fuel; and
a state determination element configured to determine a state of the separator in accordance with the density indicated by the signal output from the first density sensor.

2. The fuel separation device according to claim 1,
wherein the separator includes
a separation film to selectively transmit the high-octane component contained in the raw fuel, and
a high-pressure chamber and a low-pressure chamber which are partitioned by the separation film,
wherein the fuel separation device further comprises a pressure sensor configured to output a signal corresponding to a pressure of the low-pressure chamber, and
wherein the state determination element is configured to determine the state of the separator using the pressure indicated by the signal output from the pressure sensor as a criterion for a determination on the state of the separator.

3. The fuel separation device according to claim 2,
wherein the high-pressure chamber comprises a chamber to which the raw fuel is supplied from the raw fuel tank, and
wherein the low-pressure chamber comprises a chamber in which a negative pressure is provided.

4. The fuel separation device according to claim 1, further comprising:
a high-octane fuel tank to accumulate the high-octane fuel; and
a fuel amount sensor configured to output a signal corresponding to an amount of the high-octane fuel accumulated in the high-octane fuel tank,
wherein the state determination element is configured to determine the state of the separator using the amount of the high-octane fuel indicated by the signal output from the fuel amount sensor as a criterion for a determination on the state of the separator.

5. The fuel separation device according to claim 1, further comprising:
a second density sensor configured to output a signal corresponding to a density of the high-octane component contained in the high-octane fuel,
wherein the state determination element is configured to determine the state of the separator using the density indicated by the signal output from the second density sensor as a criterion for a determination on the state of the separator.

6. The fuel separation device according to claim 1,
wherein the raw fuel tank is provided to accumulate the low-octane fuel, and
wherein the first density sensor is configured to output a signal indicative of a density of the high-octane component in the raw fuel or in the low-octane fuel.
